(19) United States
(12) Patent Application Publication
(10) Pub. No.: US 2022/0090937 A1
(43) Pub. Date: Mar. 24, 2022

(54) MAPPING OF A DRIVABLE AREA FOR VEHICLE NAVIGATION

(71) Applicant: FORD GLOBAL TECHNOLOGIES, LLC, Dearborn, MI (US)

(72) Inventors: Elena Lazaridis, Rösrath (DE); Marc Roeber, Düsseldorf (DE); Florian Vieten, Meerbusch (DE)

(21) Appl. No.: 17/469,022

(22) Filed: Sep. 8, 2021

(30) Foreign Application Priority Data
Sep. 24, 2020 (DE) 102020211960.0

(51) Int. Cl. G01C 21/00; H04W 4/38; H04W 4/029; B60W 60/00; B60W 40/08

(52) U.S. Cl. CPC G01C 21/3826; H04W 4/38; H04W 4/029; H04M 1/72; B60W 40/08; G01C 21/3837; B60W 60/001

(57) ABSTRACT

An area which is to be defined as drivable by a vehicle is mapped by tracking the movement of a person such as the driver of the vehicle during a set-up procedure. The person travels along the boundaries of the area to be drivable and the area is mapped by a program using sensors to monitor the path of movement. Other areas within the already mapped area can also be mapped as drivable or as non-drivable.

### CROSS REFERENCE TO RELATED APPLICATIONS

This application claims priority to application DE102020211960.0, filed in the German Patent and Trademark Office on Sep. 24, 2020, which is incorporated herein by reference in its entirety.

### STATEMENT REGARDING FEDERALLY SPONSORED RESEARCH

Not Applicable.

### BACKGROUND OF THE INVENTION

The present invention relates in to a method for mapping an area to be designated as drivable for a partially or fully automated vehicle by tracking the movement of a person to define the area, as well as a vehicle apparatus for performing the method. For automatic parking of a vehicle that is at least partially automated, it is necessary to know the conditions (e.g., layout and obstacles) in an environment (i.e., a site or locale) in which the vehicle is to park. Partially automated vehicles may be designed for automatic parking by means of an assistance system. Conventional sensing techniques may not be accurate enough to ensure safe parking in any particular environment when used in automotive applications. This applies in particular to the detection of small objects, discontinuities (i.e., height differences) in the roadway, and/or objects that should not be driven over, for example flower beds. This, in turn, can lead to an available parking site not being used efficiently. Specialized sensors which are designed to detect these objects may be costly and therefore not necessarily suitable for automotive applications.

### SUMMARY OF THE INVENTION

An object of the invention is to provide an efficient method for detecting an area in which a vehicle can or cannot maneuver at least semi-automatically. This object is advantageously achieved by a method for mapping at least a first area within a particular site which is drivable by a vehicle by tracking the movement of a person. The method has the steps of positioning the vehicle in the site, starting a program for mapping, capturing a reference position to which the mapping relates, moving the person along the boundary of the area, tracking the movement of the person by means of at least one sensor of the vehicle while recording the movement pattern in the site by the program, and then assessing the recording.

With the method according to the invention, information about a drivable area can be provided in an advantageous way. The method enables simple and fast mapping of the corresponding site without the need to use costly sensors. The movement of the person can be tracked with standard sensors which are typically present in modern vehicles. Advantageously, the person moves along the boundaries of the first area, which are marked as a result and which should not be driven over by the vehicle. In other words, the person moves along the boundaries so that the boundaries of the area are mapped.

The mentioned reference position can be determined, for example, by GPS (Global Positioning System) tracking and/or by detecting certain landmarks (for example by feature vectors), or by using other sensors. This is especially advantageous for partially or fully automated driving in the site mapped according to the invention, for example in an automated parking process (i.e., driverless control). For this purpose, it is necessary that the vehicle correctly re-locates and positions itself within the map with the help of the reference position. In other words, the recorded movement area must be placed correctly in the current environment. Positioning (e.g., GPS coordinates) of a drivable area and boundaries as assessed herein can be provided to an automated driving or guidance controller in order to navigate according to the drivable and/or non-drivable areas.

The method is also advantageous for vehicles controlled by a driver, since when driving over the area boundaries, the vehicle could, for example, initiate braking and/or direct acoustic and visual warnings to the driver. This would be useful, for example, if the various sites are not recognizable by the driver—for example at night or on snowy terrain. Preferably, the vehicle is at least a partially automated vehicle. The method is particularly advantageous for a partially automated vehicle because it can move within certain limits and past obstacles on the basis of the mapped area without the influence of a driver.

Preferably, the person involved in the method is an occupant of the vehicle who starts the program before or after leaving the vehicle. This can be the driver or another person. The program is started via an interface, also known as a human-machine interface. Accordingly, the program can be started via an interface in the vehicle (for example a touch screen). Preferably, the person themself starts the program by means of a device for remote control, for example by means of a smartphone on which an appropriate app is installed, for example the FordPass™ App which is a mobility app available from Ford Motor Company, Dearborn, Mich.

Preferably, the movement pattern of the person corresponds to a closed loop. This means that the person moves in such a way that at the end of the movement they arrive back at the place where they started. Alternatively, it is also conceivable that the movement pattern is open, for example in the form of a C, and in the program the two endpoints can be joined with each other by means of a straight line. A user can then assess the stored area.

After the boundaries of the area have been travelled, the mapping can be completed manually, e.g., by entering a corresponding command in the program, for example in an app of a remote control device. If the person has not yet returned to the starting position, the program will preferably offer a proposed completion for the mapped area. Furthermore, the mapping result can also be saved and completed at a later date if the boundaries of the area have not been completely travelled. Alternatively, when the starting position is reached, e.g., when the loop is closed, the mapping can be terminated automatically. The mapped area is displayed by a display, for example via an interface in the vehicle or by means of the screen of a smartphone. Advantageously, the reference position of the vehicle may also be displayed. Furthermore, the mapping result can be overlaid by an image provided via satellite if it is suitably available.

The assessment of the result of the mapping may be carried out by the program and/or the person or another user of the vehicle. The program may typically classify an area which has been mapped by fully travelling the boundaries as a usable space with high probability. On the one hand, a person can assess the usability of a mapped area/boundaries which have not been travelled better than an automated program and can also assess the mapped area in relation to the environment being examined. The data to be recorded can be saved if the result of the mapping is considered usable. The corresponding data can also be deleted without saving if the result of the mapping is assessed to be unusable.

Preferably, in the method, a recorded area or multiple recorded areas can be changed after completion of the recording by editing by means of an input via an interface (e.g., in the vehicle or on the smartphone). A user is shown points along the contour of the recorded area, which he can, for example, move with his finger on a touch screen and thus advantageously adapt more precisely to the actual local conditions.

Preferably, data related to other areas can be added to the mapped first area. The data can relate to other drivable areas as well as areas which are not to be driven. The user can give each recorded area an attribute, such as drivable and non-drivable. Thus, advantageously, multiple regions can be recorded, which can then be connected by means of their attributes.

Particularly preferably, the person marks by his movement at least a second area, which should not be driven, contained within the first drivable area. The second area can also be called a restricted area. These are, for example a flower bed, a pond, or a construction site. The person travels the boundaries of the second area in a way analogous to the first area and suitably marks this in the program. The steps defined above are performed to map an area, wherein it begins with starting the program if it is not already running. If the program is already running, because the first area has just been mapped, the reference position has already been determined. In this case, the method continues with the movement of the person along the boundaries of the second area.

Preferably, the second area is marked at a later time than the first area, and the second area is added to the mapping of the first area at this later time. As a result, an already mapped area can be advantageously used, and later changes, for example a construction site or a landscaped bed, can be added. The second area can also be deleted at a later date if temporary restriction areas such as a construction site have been removed. Furthermore, other areas can also be marked in the method.

Another aspect of the invention relates to a vehicle with at least one sensor and at least one control device which is designed to control a method according to the invention. The vehicle is in the form of an at least partially automated vehicle. The advantages of the vehicle according to the invention correspond to the advantages of the method according to the invention. In particular, the vehicle may include a driver assistance system for at least partial autonomous control of the vehicle, a sensor system for monitoring a region around the vehicle, a control device, and an interface device coupled to the control device. The control device and the interface device may be configured to perform a method for mapping a first area which is drivable by a vehicle at a site. The method may comprise positioning the vehicle at the site so that the sensor system is positioned to monitor the first area, initiating a mapping program which captures a reference position at the site, moving a person along a boundary of the first area, tracking the movement of the person using the sensor and recording the movement pattern with the mapping program, assessing the recorded movement pattern to confirm the boundary and to designate the first area as drivable.

### BRIEF DESCRIPTION OF THE DRAWINGS

FIG. 1 is an overhead view of a site with a drivable area to be mapped.

FIG. 2 is a flowchart showing an embodiment of the method according to the invention.

FIG. 3 is an overhead view of a site with a drivable area to be mapped and a non-drivable area to be mapped.

FIG. 4 is an overhead view of the site of FIG. 3 showing mapping of the non-drivable area.

FIG. 5 is an overhead view of the site of FIGS. 3 and 4 showing the resulting map.

FIG. 6 is a plan view showing a smartphone suitable for carrying out the method of FIG. 2.

### DETAILED DESCRIPTION OF PREFERRED EMBODIMENTS

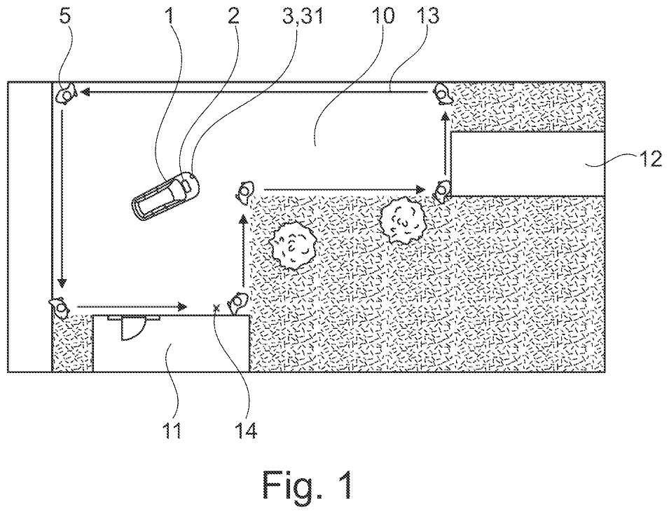

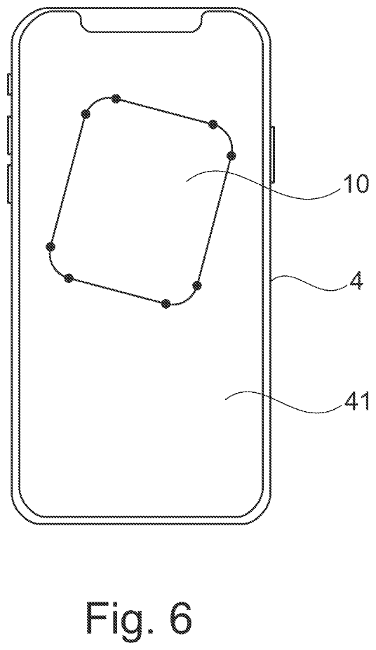

In a situation according to FIG. 1, a vehicle 1 according to the invention is positioned in a site (e.g., a home site) where it is desired to define a first drivable area 10. The vehicle 1 is at least partially automated, e.g., it has at least one driving assistance system that can independently carry out one aspect of the parking process without driver intervention (for example steering). The vehicle 1 has a control device 2 which is designed to receive and process signals from sensors 3 which capture a movement of a person and to display them, based on the movement pattern of the person, in a program for mapping the area 10 and the site on a display of an interface in the vehicle 1 or in an external control device (located outside the vehicle). An external control device is, for example, a smartphone 4 (FIG. 6), on which, for example, the FordPass™ app is installed, which can be used to operate the program, and on the display 41 of which the area 10 can be displayed. Of course, other apps and/or interfaces can also be used.

A camera 31 may be used as the sensor 3. Alternatively or additionally, a radar device, a lidar device, and/or an ultrasonic device may be used as sensors 3 without being limited to this number. Furthermore, GPS data can be used to track the movement of a person when a GPS device is present or available (e.g., installed in the vehicle 1 or provided externally in smartphone 4 or another device).

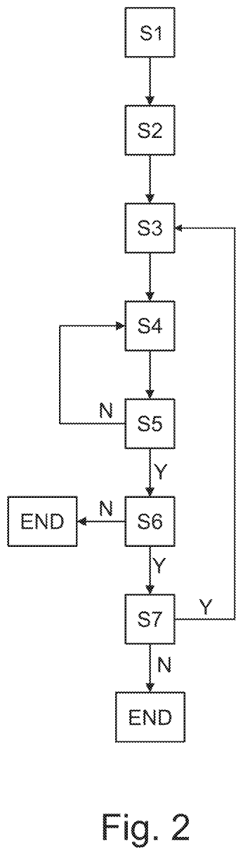

The first drivable area 10 at the home site includes a courtyard (driveway) between a residential building 11 and a garage 12. The vehicle 1 is to drive through the first area 10 and be parked in the garage 12. In order to map the area, in a method according to FIG. 2, the vehicle 1 is preferably positioned in the drivable first area 10 in a first step S1. Then, in a second step S2, the program for mapping is started. The program may be started by a driver 5 using a smartphone 4 on which a FordPass™ app is installed. for example. Alternatively, the program can also be started via an interface input which is incorporated in vehicle 1.

In a third step S3, the driver 5 moves out of vehicle 1 to a starting point 14, and from there initiates a movement around the first area 10 along the boundaries 13 thereof. The driver 5 enters information into the program when the movement for mapping is starting. Alternatively, another occupant from the vehicle 1 may move around the first area, or another person who has not previously been in the vehicle 1. The driver 5 travels a closed loop along the boundaries 13 to the starting point 14.

In a fourth step S4, the movement of the driver 5 is tracked by means of the camera 31 of the vehicle 1. The movement pattern of the person is recorded by the program and the outlines of the first area 10 are mapped. The fourth step S4 runs synchronously with the third step S3.

In a fifth step S5, the progress of the mapping is captured. If the mapping is not yet complete (N, for No), the method returns to step S4. Once the mapping is complete (Y, for Yes), the method continues to a sixth step S6.

In step S6, the mapping result is assessed by the driver 5. If the driver 5 is satisfied with the result (Y), it is saved and can be used by the vehicle 1 for use during parking. If the driver 5 is not satisfied with the result (N), the data can be discarded. The method can then be repeated, or the program can also be terminated (END).

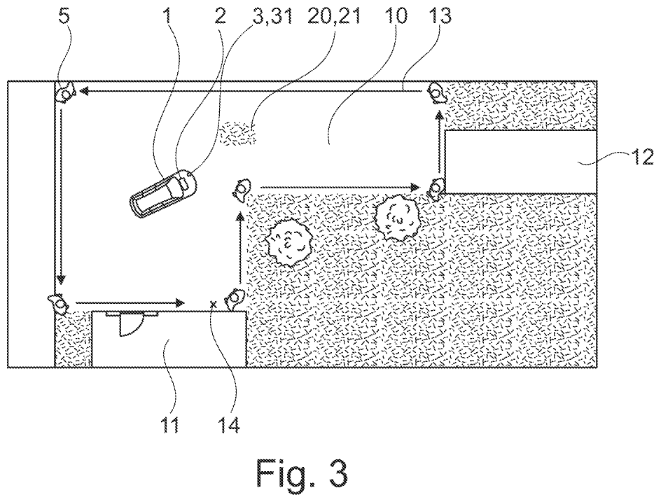

In a seventh step S7, it is decided whether to map another area which can be added to (or subtracted from) the first area 10. If not (N), the method is terminated (END). If another area is to be mapped (Y), the method runs in a loop to step S3 and the steps of the method are carried out for a second area 20 (see FIG. 3-5) as described for the first area 10 and, if necessary, analogously for other areas.

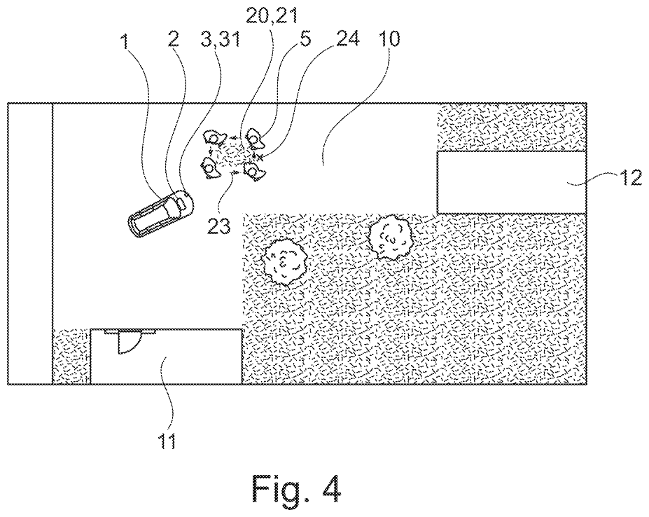

In a situation according to FIG. 3, a second area 20 is marked within the first area 10. In the example this second area 20 is a flower bed 21, which should not be driven upon. For this purpose, the second area 20 is also mapped analogously to the first area 10. The method described in FIG. 2 is then continued according to FIG. 4 in such a way that the driver 5 decides after mapping the first area 10 in step S7 that the method should be continued and the second area 20 should be mapped.

In step S7, it is selected on the control panel of the remote control that another area within the first area 10 is to be mapped. As mentioned above, the method then runs again from step S3 for mapping the second area 20.

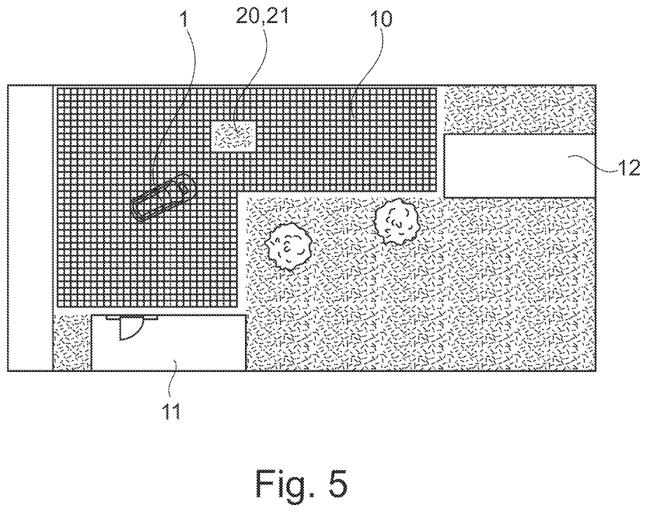

In step S3, the driver 5 goes to a starting point 24, starts his movement around the second area 20 and travels a complete loop along the boundaries 23 of the second area 20 until he reaches the starting point 24 again (FIG. 4). In the simultaneously running step S4, the movement of the driver 5 is tracked by means of the camera 31 of the vehicle 1. The movement pattern of the driver 5 is recorded by the program and the outlines of the second area 20 are mapped and inserted into the first area 10 as a non-drivable area. The finished mapping of the first area 10 with the second area 20 is shown in FIG. 5.

Steps S5-S7 run analogously as described above for the first area 10 when mapping the second area 20.

The driver 5 saves the result of the mapping according to the view of the mapped area and terminates the program manually. As explained above, other areas, which are not to be driven, within the first area 10 can also be captured and added to the mapping. Further areas can also be mapped which can be driven or if appropriate should not be driven and which are adjacent to the first area 10. The method would then be continued after step S7 with the mapping of another area analogous to steps S3 to S7 described above for capturing another area.

In a further embodiment of the method according to the invention, the second area 20 is mapped at a later time. For this purpose, the file stored in memory with the mapped first area 10 is opened in the mapping program and the mapping of the second area 20 with the steps S1 to S7 described in FIG. 2 is started. This adds another area to an existing mapping. In an analogous way, further areas can be added to an existing mapping at any time. In the same way, individual mapped areas within the first area 10 can also be deleted at any time if the characteristics characterizing them (for example a construction site) are no longer present.

In a further embodiment of the method according to the invention, the driver or possibly another user changes the recorded areas after completion of the recording. The user enters corresponding changes on the touchscreen of the smartphone 4 (or a display in the vehicle 1, for example) by means of finger contact (FIG. 6). For example, the driver is shown a mapped area 10 having a boundary includes points along the contour of the recorded area, which he can move with his fingers.

What is claimed is:

1. A method for mapping a first area which is drivable by a vehicle at a site, comprising the steps of:
positioning the vehicle at the site so that a sensor in the vehicle is positioned to monitor the first area;
initiating a mapping program which captures a reference position at the site;
moving a person along a boundary of the first area;
tracking a movement of the person using the sensor and recording the movement pattern with the mapping program; and
assessing the recorded movement pattern to confirm the boundary and to designate the first area as drivable.

2. The method of claim 1, wherein the vehicle is configured for at least partial automated driving.

3. The method of claim 1, wherein the person is an occupant of the vehicle.

4. The method of claim 1, wherein the person launches the program using a remote device.

5. The method of claim 4, wherein the remote device is comprised of a smartphone device.

6. The method of claim 1, wherein the movement pattern of the person corresponds to a closed loop.

7. The method of claim 6, wherein completion of the closed loop automatically initiates the assessing of the boundary.

8. The method of claim 1, wherein the first area as represented by the recorded movement pattern can be changed after completion of the recording by manual editing using an interface device.

9. The method of claim 1, wherein data related to a second area is added to the mapping of the first area.

10. The method of claim 9, wherein in the second area is a non-drivable area within the first area, and wherein the second area is defined by the steps of:
moving the person along a boundary of the second area;
tracking the movement of the person using the sensor and recording the second movement pattern with the mapping program; and
assessing the second recorded movement pattern to confirm the boundary and to designate the second area as non-drivable.

11. The method of claim 9, wherein the second area is defined at a later time than the first area, and wherein the second area is added to the mapping of the first area at this later time.

12. A vehicle comprising:
a driver assistance system for at least partial autonomous control of the vehicle;
a sensor system for monitoring a region around the vehicle;
a control device; and
an interface device coupled to the control device;
wherein the control device and the interface device are configured to perform a method for mapping a first area which is drivable by a vehicle at a site, wherein the method comprises the steps of:
positioning the vehicle at the site so that the sensor system is positioned to monitor the first area;
initiating a mapping program which captures a reference position at the site;
moving a person along a boundary of the first area;
tracking a movement of the person using the sensor and recording a movement pattern with the mapping program; and
assessing the recorded movement pattern to confirm the boundary and to designate the first area as drivable.

13. The vehicle of claim 12, wherein the person is an occupant of the vehicle.

14. The vehicle of claim 12, wherein the interface device comprises a remote device, and wherein the person starts the program using the remote device.

15. The vehicle of claim 12, wherein the movement pattern of the person corresponds to a closed loop.

16. The vehicle of claim 15, wherein completion of the closed loop automatically initiates the assessing of the boundary.

17. The vehicle of claim 12, wherein the first area as represented by the recorded movement pattern can be changed after completion of the recording by manual editing using the interface device.

18. The vehicle of claim 12, wherein data related to a second area is added to the mapping of the first area.

19. The vehicle of claim 18, wherein the second area is a non-drivable area within the first area, and wherein the second area is defined by the steps of:
moving the person along a boundary of the second area;
tracking a second movement of the person using the sensor and recording a second movement pattern with the mapping program; and
assessing the second recorded movement pattern to confirm the boundary and to designate the second area as non-drivable.

20. The vehicle of claim 18, wherein the second area is defined at a later time than the first area, and wherein the second area is added to the mapping of the first area at this later time.
